(19) United States
(12) Patent Application Publication
(10) Pub. No.: US 2023/0176584 A1
(43) Pub. Date: Jun. 8, 2023

(54) GUIDANCE FOR AN OUTDOOR ROBOTIC WORK TOOL TO AN OUTDOOR ROBOTIC WORK TOOL INTERACTION STATION

(71) Applicant: HUSQVARNA AB, Huskvarna (SE)

(72) Inventors: Mattias Kamfors, Jönköping (SE); Rickard Landin, Jönköping (SE)

(21) Appl. No.: 17/924,759

(22) PCT Filed: Jun. 4, 2021
(86) PCT No.: PCT/EP2021/064963

§ 371 Date: Nov. 11, 2022

(30) Foreign Application Priority Data
Jun. 9, 2020 (SE) 2050677-0

(51) Int. Cl. G05D 1/02; A01D 34/00

(52) U.S. Cl. CPC G05D 1/0225; G05D 1/0257; G05D 1/0278; A01D 34/008; G05D 2201/0208; A01D 2101/00

(57) ABSTRACT

The present disclosure relates to an outdoor robotic work tool interaction station (200) having a longitudinal extension (E) along which the interaction station (200) is adapted to receive an oncoming outdoor robotic work tool (100), and a vertical extension (V) that is perpendicular to the longitudinal extension (E). The interaction station (200) further comprises at least one radar reflective target (211, 212, 213).

### TECHNICAL FIELD

The present disclosure relates to outdoor robotic work tool interaction station and an outdoor robotic work tool, and in particular guidance of an outdoor robotic work tool to an outdoor robotic work tool interaction station. The outdoor robotic work tool can for example be constituted by a robotic lawn mower, and the outdoor robotic work tool interaction station can for example be constituted by a charging station.

### BACKGROUND

Automated or robotic power tools such as robotic lawn mowers are becoming increasingly more popular. In a typical deployment a work area, such as a garden, the work area is enclosed by a boundary wire with the purpose of keeping the robotic lawn mower inside the work area. An electric control signal may be transmitted through the boundary wire thereby generating an (electro-) magnetic field emanating from the boundary wire. The robotic working tool is typically arranged with one or more sensors adapted to sense the control signal.

The robotic lawn mower can then cut grass on a user's lawn automatically and can be charged automatically without intervention of the user, and no longer needs to be manually managed after being set once. The robotic lawn mower 1 typically comprises charging skids for contacting corresponding contact plates in a charging station when docking into the charging station for receiving a charging current through, and possibly also for transferring information by means of electrical communication between the charging station and the robotic lawn mower.

The boundary wire is often used to guide the robotic lawn mower to the charging station, but it is desired to have alternative means for guiding the robotic lawn mower to the charging station. This is of particular interest in the cases where other types of guiding systems are used instead of a boundary wire, for example a navigation sensor for a beacon navigation and/or a satellite navigation. The beacon navigation sensor may be a radio frequency (RF) receive configured to receive signals from an RF beacon, and the satellite navigation sensor may be a GPS (Global Positioning System) device or other Global Navigation Satellite System (GNSS) device.

There is thus a need to provide improved and alternative means for guiding an outdoor robotic work tool, such as a robotic lawn mower, to a charging station or any other type of interaction station.

### SUMMARY

The object of the present disclosure is to provide improved and alternative means for guiding an outdoor robotic work tool, such as a robotic lawn mower, to a charging station or any other type of interaction station.

This object is achieved by means of an outdoor robotic work tool interaction station having a longitudinal extension along which the interaction station is adapted to receive an oncoming outdoor robotic work tool, and a vertical extension that is perpendicular to the longitudinal extension. The interaction station further comprises at least one radar reflective target.

This enables an outdoor robotic work tool to identify and move towards the outdoor robotic work tool interaction station in a suitable manner without the need of other guiding means such as boundary wires.

According to some aspects, the interaction station comprises at least two radar reflective targets.

According to some aspects, at least two radar reflective targets are separated along the longitudinal extension.

In this manner, the radar reflective targets are easily distinguishable from each other.

According to some aspects, at least two radar reflective targets are separated along the vertical extension.

In this manner, the radar reflective targets do not obscure each other at certain angles.

According to some aspects, the interaction station is an outdoor robotic work tool charging station that comprises a charging transmission arrangement adapted for receiving, and making electrical contact with, a charging reception arrangement of an outdoor robotic work tool in order to be able to provide a charging current to the outdoor robotic work tool.

In this manner, an outdoor robotic work tool can easily find, move towards and connect to a charging station, without the need of other guiding means such as boundary wires.

According to some aspects, the outdoor robotic work tool interaction station comprises a base portion and a top portion, where the top portion comprises the contact plates. The base portion and the top portion are vertically separated along the vertical extension.

In this manner a compact and functional unit is provided.

According to some aspects, at least one radar reflective target is attached to the top portion.

In this manner, the radar reflective target is easily detectable.

According to some aspects, the charging station comprises an intermediate part that connects the base portion and a top portion. For example, at least one radar reflective target is attached to the intermediate part.

In this manner, a vertical separation between radar reflective targets is enabled.

According to some aspects, the outdoor robotic work tool interaction station is a robotic lawn mower charging station.

According to some aspects, at least one radar reflective target is made in a metallic or plastic material. For example, at least one radar reflective target is made as a corner radar reflector formed as an open pyramid that has three wall sides and an open side.

This means that radar reflective targets can be easily manufactured at a low cost, and that standard corner reflectors can be used.

This object is also achieved by means of an outdoor robotic work tool adapted for a forward travelling direction and comprising a control unit, a charging reception arrangement adapted for making electrical contact with a charging transmission arrangement of an outdoor robotic work tool charging station, and at least one radar transceiver adapted to transmit signals and to receive reflected signals that have been reflected by at least one object. The control unit is adapted to identify radar detections originating from received reflected signals that have been reflected by at least one radar reflective target, positioned at an outdoor robotic work tool interaction station. The control unit is further adapted to control the movement of the outdoor robotic work tool such that it moves towards the outdoor robotic work tool interaction station in dependence of information acquired by means of the of the radar transceivers.

This enables the outdoor robotic work tool to identify and move towards the outdoor robotic work tool interaction station in a suitable manner without the need of other guiding means such as boundary wires.

According to some aspects, the outdoor robotic work tool interaction station is an outdoor robotic work tool charging station, where the control unit is adapted to control the movement of the outdoor robotic work tool such that it moves to such a position at the outdoor robotic work tool charging station that enables the charging reception arrangement to make electrical contact with the charging transmission arrangement. This enables the outdoor robotic work tool to receive a charging current from the outdoor robotic work tool charging station.

This enables the outdoor robotic work tool to identify and move towards the outdoor robotic work tool charging station in a suitable manner without the need of other guiding means such as boundary wires.

According to some aspects, the control unit is adapted to identify radar detections originating from received reflected signals that have been reflected by at least two radar reflective targets by comparing the configuration of the radar detections with a predetermined configuration of the radar reflective targets.

This enables the outdoor robotic work tool to distinguish between radar detections originating from received reflected signals that have been reflected by radar reflective targets and radar detections originating from received reflected signals that have been reflected by other items. This lowers the risk for false detections.

According to some aspects, the control unit is adapted to distinguish between different outdoor robotic work tool interaction stations by comparing the configuration of the radar detections with different predetermined unique configurations of radar reflective targets that are associated with corresponding outdoor robotic work tool interaction stations. This enables the control unit to identify a certain outdoor robotic work tool interaction station among at least two outdoor robotic work tool interaction stations.

According to some aspects, the outdoor robotic work tool comprises at least one navigation sensor arrangement that comprises a beacon navigation sensor and/or a satellite navigation sensor.

According to some aspects, the control unit is adapted to identify radar detections originating from received reflected signals that have been reflected by at least one radar reflective target by comparing a calculated position of said radar reflective target with a predetermined position of said radar reflective target.

According to some aspects, the control unit is adapted to identify radar detections originating from received reflected signals that have been reflected by at least two radar reflective targets by comparing calculated positions of said radar reflective targets with predetermined positions of said radar reflective targets.

This means that the outdoor robotic work tool is enabled to determine a preliminary position of the outdoor robotic work tool interaction station, which makes it easier to determine that certain radar detections originate from received reflected signals that have been reflected by radar reflective targets. This lowers the risk for false detections.

According to some aspects, the control unit is adapted to calibrate a position of an outdoor robotic work tool interaction station in dependence of a determined position of at least one radar reflective target, positioned at the outdoor robotic work tool interaction station.

This enables an uncomplicated and reliable calibration.

The present disclosure also relates to methods that are associated with above advantages.

### BRIEF DESCRIPTION OF THE DRAWINGS

The present disclosure will now be described more in detail with reference to the appended drawings, where:

FIG. 1A shows a perspective side view of a robotic lawn mower;

FIG. 1B shows a schematic overview of the robotic lawn mower;

FIG. 2A shows a schematic side view of a robotic lawn mower charging station;

FIG. 2B shows a schematic top view of a robotic lawn mower charging station;

FIG. 3A shows a schematic front view of a radar reflective target;

FIG. 3B shows a schematic perspective side view of a radar reflective target;

FIG. 4A shows a first schematic top view of a lawnmower and a charging station;

FIG. 4B shows a second schematic top view of a lawnmower and a charging station;

FIG. 5 shows a computer program product; and

FIG. 6 shows a flowchart for methods according to the present disclosure.

### DETAILED DESCRIPTION

Aspects of the present disclosure will now be described more fully hereinafter with reference to the accompanying drawings. The different devices, systems, computer programs and methods disclosed herein can, however, be realized in many different forms and should not be construed as being limited to the aspects set forth herein. Like numbers in the drawings refer to like elements throughout.

The terminology used herein is for describing aspects of the disclosure only and is not intended to limit the invention. As used herein, the singular forms “a”, “an” and “the” are intended to include the plural forms as well, unless the context clearly indicates otherwise.

It should be noted that even though the description given herein will be focused on robotic lawn mowers, the teachings herein may also be applied to any type of outdoor robotic work tool, such as for example robotic ball collectors, robotic mine sweepers and robotic farming equipment.

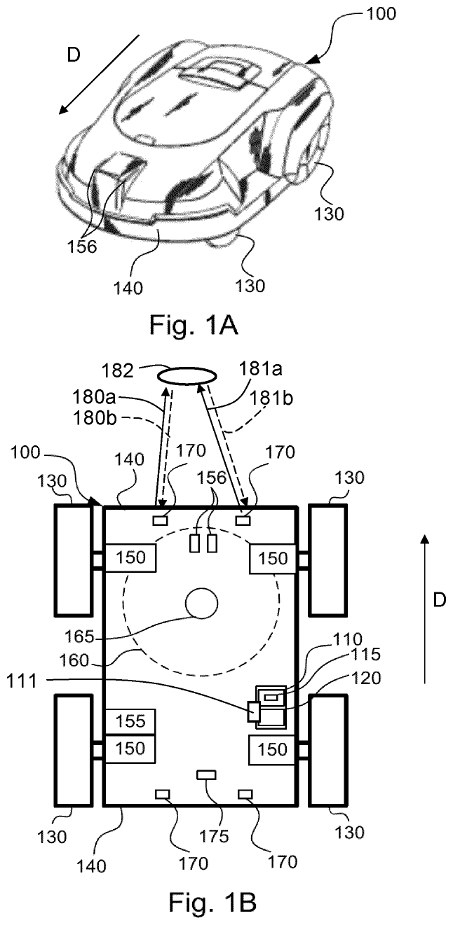

FIG. 1A shows a perspective view of a robotic lawn mower 100 and FIG. 1B shows a schematic overview of the robotic lawn mower 100. The robotic lawn mower 100 is adapted for a forward travelling direction D, has a body 140 and a plurality of wheels 130; in this example the robotic lawnmower 100 has four wheels 130, two front wheels and two rear wheels. The robotic lawn mower 100 comprises a control unit 110 and at least one electric motor 150, where at least some of the wheels 130 are drivably connected to at least one electric motor 150. It should be noted that even if the description herein is focused on electric motors, combustion engines may alternatively be used in combination with an electric motor arrangement. The robotic lawn mower 100 may be a multi-chassis type or a mono-chassis type. A multi-chassis type comprises more than one body parts that are movable with respect to one another. A mono-chassis type comprises only one main body part.

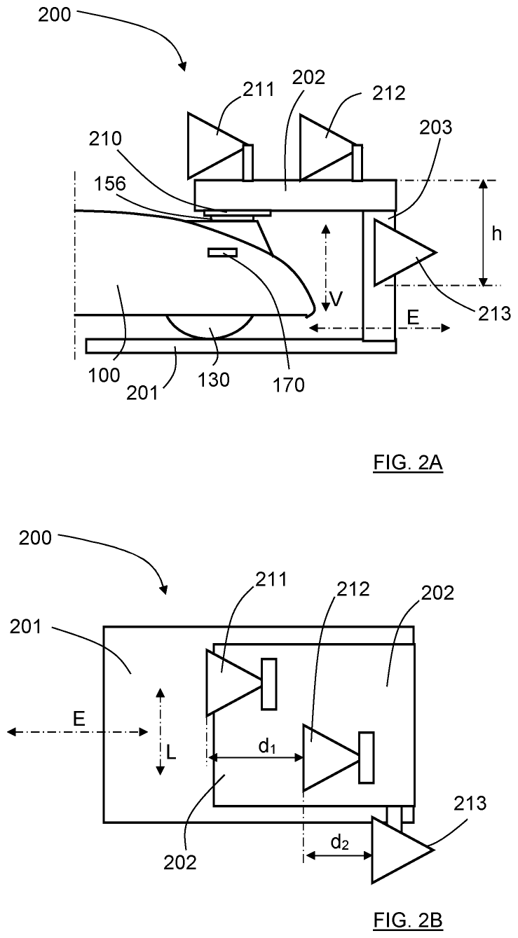

With reference also to FIG. 2A, showing a side view of the robotic lawn mower 100 being docked to a robotic lawn mower charging station 200, the robotic lawn mower 100 comprises charging skids 156 for contacting contact plates 210 of a charging station 200 when docking into 200 charging station 200 for receiving a charging current, and possibly also for transferring information by means of electrical communication between the charging station and the robotic lawn mower 100.

In this example embodiment, the robotic lawnmower 100 is of a mono-chassis type, having a main body part 140. The main body part 140 substantially houses all components of the robotic lawnmower 100.

The robotic lawnmower 100 also comprises a grass cutting device 160, such as a rotating blade 160 driven by a cutter motor 165. The grass cutting device being an example of a work tool 160 for a robotic working tool 100. The robotic lawnmower 100 also has at least one rechargeable electric power source such as a battery 155 for providing power to the electric motor arrangement 150 and/or the cutter motor 165. The battery 155 is arranged to be charged by means of received charging current from the charging station 200, received through charging skids 156 or other suitable charging connectors. Inductive charging without galvanic contact, only by means of electric contact, is also conceivable; the charging skids 156 and the contact plates 210 are generally constituted by a charging reception arrangement 156 and a charging transmission arrangement 210. The battery is generally constituted by a rechargeable electric power source 155 that comprises one or more batteries that can be separately arranged or be arranged in an integrated manner to form a combined battery.

In one embodiment, the robotic lawnmower 100 may further comprise at least one navigation sensor arrangement 175. In one embodiment, the navigation sensor arrangement 175 comprises one or more sensors for deduced navigation. Examples of sensors for deduced reckoning are odometers, accelerometers, gyroscopes, and compasses to mention a few examples. In one embodiment, the navigation sensor arrangement 175 comprises a beacon navigation sensor and/or a satellite navigation sensor 190. The beacon navigation sensor may be a Radio Frequency receiver, such as an Ultra Wide Band (UWB) receiver or sensor, configured to receive signals from a Radio Frequency beacon, such as a UWB beacon. Alternatively or additionally, the beacon navigation sensor may be an optical receiver configured to receive signals from an optical beacon. The satellite navigation sensor may be a GPS (Global Positioning System) device or other Global Navigation Satellite System (GNSS) device.

The robotic lawn mower 100 further comprises radar transceivers 170 adapted to transmit signals 180a, 181a and to receive reflected signals 180b, 181b that have been reflected by an object 182. To enable this, according to some aspects, each detector transceiver 170 comprises a corresponding transmitter arrangement and receiver arrangement together with other necessary circuitry in a well-known manner.

For this purpose, the control unit 110 is adapted to control the radar transceivers 170 and to control the speed and direction of the robotic lawn mower 100 in dependence of information acquired by means of the of the radar transceivers 170 when the robotic lawn mower 100 is moving. The control unit 110 can be constituted by several separate control sub-units or one single integrated control unit. The control unit 110 is adapted to perform all necessary signal processing necessary for controlling the radar transceivers 170 and to acquire the desired information from the detected measurement results.

By means of the radar transceivers 170, objects and obstacles can be detected well in advance, preventing collisions to occur.

With reference also to FIG. 2B that shows a top view of the charging station 200, the charging station 200 has a longitudinal extension E along which the charging station 200 is adapted to receive an oncoming outdoor robotic work tool 100. According to the present disclosure, the charging station 200 further comprises at least one radar reflective target 211, 212, 213, in this example a first radar reflective target 211, a second radar reflective target 212 and a third radar reflective target 213.

According to some aspects, there are at least two radar reflective targets are separated along the longitudinal extension E, here all three radar reflective targets 211, 212, 213 are separated along the longitudinal extension E, where the first radar reflective target 211 and the second radar reflective target 212 are separated by a first distance d₁ along the longitudinal extension E, and the second radar reflective target 212 and the third radar reflective target 213 are separated by a second distance d₂ along the longitudinal extension E. The separation of the radar reflective targets 211, 212, 213 along the longitudinal extension E is important in order to enable the radar transceivers 170 to distinguish between the radar reflective targets 211, 212, 213 and to determine how the radar reflective targets 211, 212, 213 are configured at the charging station 200.

According to some aspects, the charging station 200 comprises a base portion 201 and a top portion 202, where the top portion 202 comprises the contact plates 210. The base portion 201 and the top portion 202 are vertically separated along a vertical extension V that is perpendicular to the longitudinal extension E. At least two radar reflective targets are separated along the vertical extension V, in this example the first radar reflective target 211 and the second radar reflective target 212 are on the same vertical level along the vertical extension V, and are vertically separated from the third radar reflective target 213 along the vertical extension V by a vertical separation h. The main reason for the vertical separation h is to avoid that radar reflective targets do not obscure each other when detected from certain angles.

According to some aspects, at least one radar reflective target 211, 212 is attached to the top portion 202, in this example the first radar reflective target 211 and the second radar reflective target 212 are attached to the top portion 202.

The base portion 201 and the top portion 202 can be directly connect to each other. Alternatively, according to some aspects, the charging station 200 comprises an intermediate part 203 that connects the base portion 201 and a top portion 202, and according to some further aspects, at least one radar reflective target 211, 212 is attached to the intermediate part 203. In this example, the third radar reflective target 213 is attached to the intermediate part 203.

According to some aspects, as illustrated in FIG. 2B, at least two radar reflective target are separated along a lateral extension L that is perpendicular to the longitudinal extension E and the vertical extension V. In this example all three radar reflective targets 211, 212, 213 are separated along the lateral extension L.

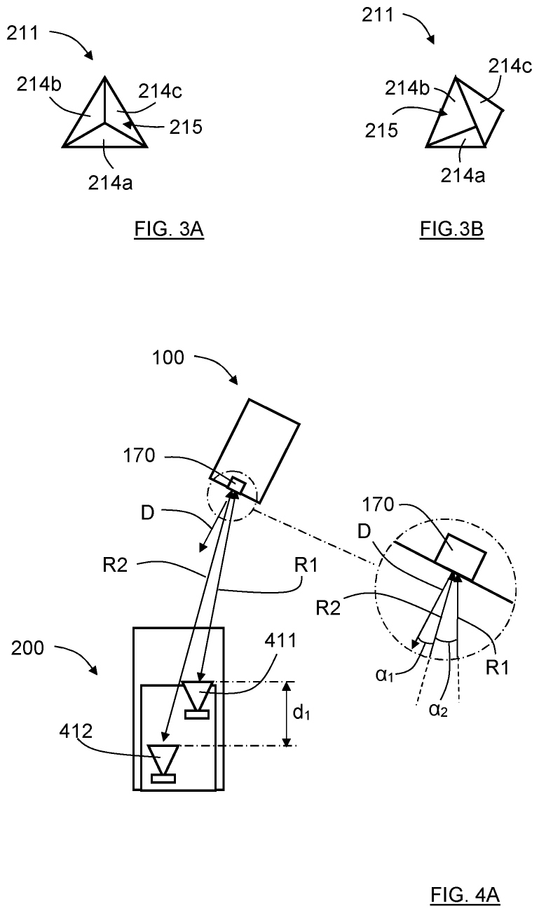

With reference also to FIG. 3A, showing a front view of the first radar reflective target 211, it is according to some aspects made in a metallic material and is a so-called corner reflector that is made as an open pyramid that has three wall sides 214a, 214b, 214c and an open side 215. This configuration is applicable for all radar reflective targets 211, 212, 213.

Other shapes of the radar reflective targets are of course conceivable, such as for example a rectangular plate, a triangular plate, and a cube with an open side. Other materials are also conceivable, such as plastic materials that have radar reflecting properties, for example plastic materials with a certain carbon content. Such materials can be suitable for 3D-printing techniques that can be applied in a manufacturing process.

In accordance with the present disclosure, the control unit 110 is adapted to identify radar detections originating from received reflected signals 180b, 181b that have been reflected by at least one radar reflective target 211, 212, 213, positioned at the charging station 200. The control unit is further adapted to control the movement of the outdoor robotic lawn mower 100 such that it moves towards the charging station 200 in dependence of information acquired by means of the of the radar transceivers 170, enabling the charging skids 156 to make electrical contact with the contact plates 210 such that the outdoor robotic lawn mower 100 can receive a charging current from the charging station 200.

This means that the control unit 110 is adapted to steer the lawn mower 100 towards the charging station 200, and park the lawn mower 100 in a charging position as shown in FIG. 2A without the need for any further equipment such as a boundary line. This means that the present disclosure is especially well suited for a lawn mower system without a boundary wire, as is the case in this example.

This is for example the case where the outdoor robotic lawn mower 100 comprises at least one navigation sensor arrangement 175 according to the above.

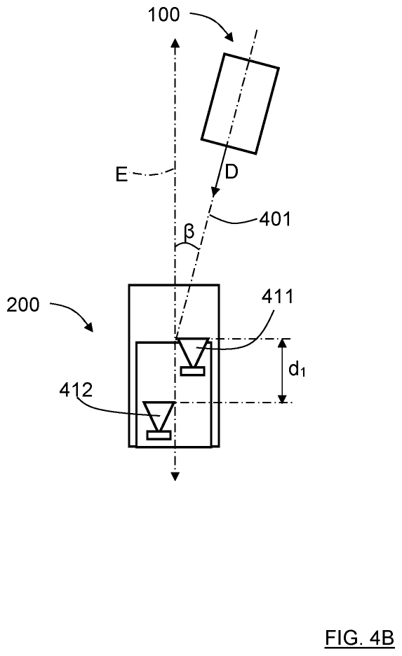

The control unit 110 is adapted to control the movement of the robotic lawn mower 100 such that it moves towards the charging station 200 using input from the radar transceivers 170. This can be accomplished in many ways, one example is provided in the following with reference to FIG. 4A showing a schematic top view of a lawn mower 100 with one radar transceiver 170 and a charging station 200. Here only the two first two radar reflective targets 211, 212 are shown, being mounted to the charging station 200 at the first distance d₁ from each other along the longitudinal extension E that runs centrally through the charging station 200, where the first distance d₁ is predetermined and known to the control unit 110.

Having more than one radar reflective target, here two radar reflective targets 211, 212, comprised in the charging station 200, at the predetermined first distance d to each other allows the control unit 110 to identify the charging station 200. There is a first distance R1 between the between the radar transceiver 170 and a first radar reflective target 211, and a second distance R2 between the between the radar transceiver 170 and a second radar reflective target 212, where the control unit 110 is adapted to determine the distances R1, R2 and corresponding azimuth angles α₁, α₂ based on detected radar data regarding transmitted and received reflected signals in a previously well-known manner.

According to some aspects, the control unit 110 is adapted to identify radar detections originating from received reflected signals that have been reflected by at least two radar reflective target 211, 212 by comparing the configuration of the radar detections with a predetermined configuration of the radar reflective targets 211, 212.

According to some further aspects, as an addition to the above, or as only means for identifying radar detections, the control unit 110 is adapted to use data from the navigation sensor arrangement 175 to determine that the radar detections originate from reflections from the radar reflective target 211, 212 of the charging station 200. In order to achieve this, the control unit 110 is adapted to identify radar detections originating from received reflected signals that have been reflected by at least one radar reflective target 211, 212 by comparing a calculated position of said radar reflective target 211, 212 with a predetermined position of said radar reflective target 211, 212. This ensures that the radar detections originate from an approximate position of the charging station 200 and its associated radar reflective target 211, 212, and not from any other reflecting items in the environment.

Further, also in order to achieve this, the control unit 110 is adapted to identify radar detections originating from received reflected signals that have been reflected by at least one radar reflective target 211, 212 by comparing calculated positions of said radar reflective targets 211, 212 with predetermined positions of said radar reflective targets 211, 212. This ensures that the radar detections originate from an approximate position of the charging station 200 and its associated radar reflective targets 211, 212, and not from any other reflecting items in the environment.

With reference also to FIG. 4B, having determined determine the distances R1, R2 and corresponding azimuth angles α₁, α₂ the control unit 110 is enabled to calculate a deviation angle β between an extension 420 of the forward travelling direction D and the longitudinal extension E towards the charging station 200. The more radar reflective targets that are used at a certain charging station, the more accurate its position relative the lawn mower 100 can be determined when the configuration of the radar reflective targets is previously known. Having this information, the control unit 110 can control the movement of the robotic lawn mower 100, making it possible for the robotic lawn mower 100 to dock with the charging station 200 at an optimal angle.

According to some aspects, the control unit 110 is adapted to calibrate a position of an outdoor robotic work tool charging station 200 in dependence of a determined position of at least one radar reflective target 211, 212, 213, positioned at the outdoor robotic work tool charging station 200.

According to some aspects, the charging station is only an example and is generally constituted by an outdoor robotic work tool interaction station 200. Except charging, such an interaction station can be constituted by a maintenance stations such as a knife sharping station, or a dumping station. The latter can for example be the case when the outdoor robotic work tool can be adapted to collect items such as leafs or golf balls. Another example of an interaction station is a marker of a lawn mower off-limit area such as an area around a plant that should be left.

There can of course be two or more different outdoor robotic work tool interaction stations 200 that can have different purposes. In this case, the control unit 110 is adapted to distinguish between the different outdoor robotic work tool interaction stations 200 by comparing the configuration of the radar detections with different predetermined unique configurations of radar reflective targets 211, 212, 213 that are associated with corresponding outdoor robotic work tool interaction stations 200, enabling the control unit 110 identify a certain outdoor robotic work tool interaction station 200 among at least two outdoor robotic work tool interaction stations 200.

In FIG. 1B it is schematically illustrated, in terms of a number of functional units, the components of the control unit 110 according to embodiments of the discussions herein. Processing circuitry 115 is provided using any combination of one or more of a suitable central processing unit CPU, multiprocessor, microcontroller, digital signal processor DSP, etc., capable of executing software instructions stored in a computer program product, e.g. in the form of a storage medium 150. The processing circuitry 115 may further be provided as at least one application specific integrated circuit ASIC, or field programmable gate array FPGA. The processing circuitry thus comprises a plurality of digital logic components.

Particularly, the processing circuitry 115 is configured to cause the control unit 110 to perform a set of operations, or steps to control the operation of the robotic lawn mower 1 including, but not being limited to, controlling the radar transceivers 170, processing measurements results received via the radar transceivers 170, and the propulsion of the robotic lawn mower 100. For example, the storage medium 120 may store the set of operations, and the processing circuitry 115 may be configured to retrieve the set of operations from the storage medium 120 to cause the control unit 110 to perform the set of operations. The set of operations may be provided as a set of executable instructions. Thus, the processing circuitry 115 is thereby arranged to execute methods as herein disclosed.

The storage medium 120 may also comprise persistent storage, which, for example, can be any single one or combination of magnetic memory, optical memory, solid state memory or even remotely mounted memory.

According to some aspects, the control unit 110 further comprises an interface 111 for communications with at least one external device such as a control panel or an external device. As such the interface 111 may comprise one or more transmitters and receivers, comprising analogue and digital components and a suitable number of ports for wireline communication. The interface 111 can be adapted for communication with other devices 111, such as a server, a personal computer or smartphone, the charging station, and/or other robotic working tools. Examples of such wireless communication devices are Bluetooth®, WiFi® (IEEE802.11b), Global System Mobile (GSM) and LTE (Long Term Evolution), to name a few.

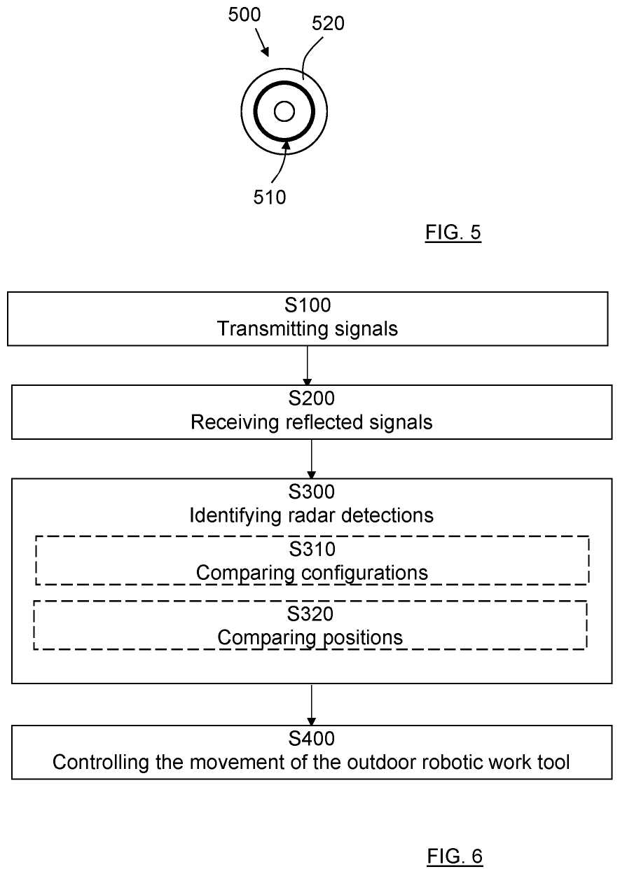

FIG. 5 shows a computer program product 500 comprising computer executable instructions 510 stored on media 520 to execute any of the methods disclosed herein.

Generally, as shown in FIG. 1-4, the present disclosure relates to an outdoor robotic work tool interaction station 200 having a longitudinal extension E along which the interaction station 200 is adapted to receive an oncoming outdoor robotic work tool 100, and a vertical extension V that is perpendicular to the longitudinal extension E. The interaction station 200 further comprises at least one radar reflective target 211, 212, 213.

According to some aspects, at least two radar reflective targets 211, 212 are separated along the longitudinal extension E, and according to some further aspects, at least two radar reflective targets 211, 212; 213 are separated along the vertical extension V.

According to some aspects, the interaction station is an outdoor robotic work tool charging station 200 that comprises a charging transmission arrangement 210 adapted for receiving, and making electrical contact with, a charging reception arrangement 156 of an outdoor robotic work tool 100 in order to be able to provide a charging current to the outdoor robotic work tool 100.

According to some aspects, the outdoor robotic work tool interaction station 200 comprises a base portion 201 and a top portion 202, where the top portion 202 comprises the contact plates 210, where the base portion 201 and the top portion 202 are vertically separated along the vertical extension V. For example, at least one radar reflective target 211, 212 is attached to the top portion 202.

According to some aspects, the charging station 200 comprises an intermediate part 203 that connects the base portion 201 and a top portion 202. For example, at least one radar reflective target 211, 212 is attached to the intermediate part 203.

According to some aspects, the outdoor robotic work tool interaction station is a robotic lawn mower charging station 200.

According to some aspects, at least one radar reflective target 211, 212, 213 is made in a metallic or plastic material. For example, at least one radar reflective target 211, 212, 213 is made as a corner radar reflector formed as an open pyramid that has three wall sides 214a, 214b, 214c and an open side 215.

Generally, as shown in FIG. 1-4, the present disclosure also relates to an outdoor robotic work tool 100 adapted for a forward travelling direction D and comprising a control unit 110, a charging reception arrangement 156 adapted for making electrical contact with a charging transmission arrangement 210 of an outdoor robotic work tool charging station 200, and at least one radar transceiver 170 adapted to transmit signals 180a, 181a and to receive reflected signals 180b, 181b that have been reflected by at least one object 182; 211, 212, 213. The control unit 110 is adapted to identify radar detections originating from received reflected signals 180b, 181b that have been reflected by at least one radar reflective target 211, 212, 213, positioned at an outdoor robotic work tool interaction station 200, and to control the movement of the outdoor robotic work tool 100 such that it moves towards the outdoor robotic work tool interaction station 200 in dependence of information acquired by means of the of the radar transceivers 170.

According to some aspects, the outdoor robotic work tool interaction station 200 is an outdoor robotic work tool charging station, where the control unit 110 is adapted to control the movement of the outdoor robotic work tool 100 such that it moves to such a position at the outdoor robotic work tool charging station 200 such that the charging reception arrangement 156 can make electrical contact with the charging transmission arrangement 210. The outdoor robotic work tool 100 can then receive a charging current from the outdoor robotic work tool charging station 200.

According to some aspects, the control unit 110 is adapted to identify radar detections originating from received reflected signals 180b, 181b that have been reflected by at least two radar reflective targets 211, 212, 213 by comparing the configuration of the radar detections with a predetermined configuration of the radar reflective targets 211, 212, 213.

According to some aspects, the control unit 110 is adapted to distinguish between different outdoor robotic work tool interaction stations 200 by comparing the configuration of the radar detections with different predetermined unique configurations of radar reflective targets 211, 212, 213 that are associated with corresponding outdoor robotic work tool interaction stations 200. This enables the control unit 110 to identify a certain outdoor robotic work tool interaction station 200 among at least two outdoor robotic work tool interaction stations 200.

According to some aspects, the outdoor robotic work tool 100 comprise at least one navigation sensor arrangement 175 that comprises a beacon navigation sensor and/or a satellite navigation sensor.

According to some aspects, the control unit 110 is adapted to identify radar detections originating from received reflected signals 180b, 181b that have been reflected by at least one radar reflective target 211, 212, 213 by comparing a calculated position of said radar reflective target 211, 212, 213 with a predetermined position of said radar reflective target 211, 212, 213.

According to some aspects, the control unit 110 is adapted to calibrate a position of an outdoor robotic work tool interaction station 200 in dependence of a determined position of at least one radar reflective target 211, 212, 213, positioned at the outdoor robotic work tool interaction station 200.

According to some aspects, the control unit 110 is adapted to identify radar detections originating from received reflected signals 180b, 181b that have been reflected by at least two radar reflective targets 211, 212, 213 by comparing calculated positions of said at least two radar reflective targets 211, 212, 213 with predetermined positions of said at least two radar reflective targets 211, 212, 213.

According to some aspects, the control unit 110 is adapted to calibrate a position of an outdoor robotic work tool interaction station 200 in dependence of determined positions of at least two radar reflective targets 211, 212, 213, positioned at the outdoor robotic work tool interaction station 200.

With reference to FIG. 6, the present disclosure also relates to a method in an outdoor robotic work tool 100 adapted for a forward travelling direction D, where the method comprises transmitting S100 signals, and receiving S200 reflected signals 180b, 181b where the transmitted signals 180a, 181a have been reflected by at least one object 182; 211, 212, 213. The method further comprises identifying S300 radar detections originating from received reflected signals 180b, 181b that have been reflected by at least one radar reflective target 211, 212, 213, positioned at an outdoor robotic work tool interaction station 200, and controlling S400 the movement of the outdoor robotic work tool 100 such that it moves towards the outdoor robotic work tool interaction station 200 in dependence of information acquired by means of the of the radar transceivers 170.

According to some aspects, the outdoor robotic work tool interaction station is an outdoor robotic work tool charging station 200, where the method comprises making electrical contact between the charging reception arrangement 156 and the charging transmission arrangement 210 such that the outdoor robotic work tool 100 can receive a charging current from the outdoor robotic work tool charging station 200.

According to some aspects, the method comprises identifying S300 radar detections originating from received reflected signals 180b, 181b that have been reflected by at least two radar reflective target 211, 212, 213 by comparing S310 the configuration of the radar detections with a predetermined configuration of the radar reflective targets 211, 212, 213.

According to some aspects, the method comprises distinguishing between different outdoor robotic work tool interaction stations 200 by comparing the configuration of the radar detections with different predetermined unique configurations of radar reflective targets 211, 212, 213 that are associated with corresponding outdoor robotic work tool interaction stations 200. This enables identification of a certain outdoor robotic work tool interaction station 200 among at least two outdoor robotic work tool interaction stations 200.

According to some aspects, the outdoor robotic work tool 100 uses at least one navigation sensor arrangement 175 with a beacon navigation sensor and/or a satellite navigation sensor.

According to some aspects, the method comprises identifying S300 radar detections originating from received reflected signals 180b, 181b that have been reflected by at least one radar reflective target 211, 212, 213 by comparing S320 a calculated position of said radar reflective target 211, 212, 213 with a predetermined position of said radar reflective target 211, 212, 213.

According to some aspects, the method comprises calibrating a position of an outdoor robotic work tool interaction station 200 in dependence of a determined position of at least one radar reflective target 211, 212, 213, positioned at the outdoor robotic work tool interaction station 200.

According to some aspects, the method comprises identifying S300 radar detections originating from received reflected signals 180b, 181b that have been reflected by at least two radar reflective targets 211, 212, 213 by comparing S320 calculated positions of said at least two radar reflective targets 211, 212, 213 with predetermined positions of said at least two radar reflective targets 211, 212, 213.

According to some aspects, the method comprises calibrating a position of an outdoor robotic work tool interaction station 200 in dependence of determined positions of at least two radar reflective targets 211, 212, 213, positioned at the outdoor robotic work tool interaction station 200.

The present disclosure is not limited to the above, but may vary freely within the scope of the appended claims. For example, each radar transceiver 170 comprises associated well-known components such as a signal generator, a transmitting and receiving device such as a transmitting/receiving antenna arrangement, and receiver circuitry. Each radar transceiver 170 can be directly controlled by the control unit 110, or comprise a sub-controller that is controlled by, and adapted to communicate with, the control unit 110.

Generally, the robotic lawn mower is an outdoor robotic work tool 100 and the robotic lawn mower charging station is an outdoor robotic work tool charging station 200.

In FIG. 2b four radar transceivers 170 are shown, two at a front of the lawn mower 100 and two at the rear of the lawn mower. There can be any number of radar transceivers 170 at any suitable positions, but there is at least one radar transceiver 170.

1. An outdoor robotic work tool interaction station having a longitudinal extension along which the interaction station is adapted to receive an outdoor robotic work tool, and a vertical extension that is perpendicular to the longitudinal extension, wherein the interaction station further comprises a first radar reflective target.

2. The outdoor robotic work tool interaction station according to claim 1, further comprising a second radar reflective target separated along the longitudinal extension from the radar reflective target.

3. The outdoor robotic work tool interaction station according to claim 2, further comprising a third radar reflective targets separated from the first or second radar reflective target along the vertical extension.

4. The outdoor robotic work tool interaction station according to claim 2, wherein the interaction station is an outdoor robotic work tool charging station that comprises a charging transmission arrangement adapted for receiving, and making electrical contact with, a charging reception arrangement of the outdoor robotic work tool in order to be able to provide a charging current to the outdoor robotic work tool.

5. The outdoor robotic work tool interaction station according to claim 4, wherein the outdoor robotic work tool interaction station comprises a base portion and a top portion, wherein the top portion comprises contact plates of the charging reception arrangement, wherein the base portion and the top portion are vertically separated along the vertical extension.

6. The outdoor robotic work tool interaction station according to claim 5, wherein at least one radar reflective target is attached to the top portion.

7. The outdoor robotic work tool interaction station according to claim 5, wherein the charging station comprises an intermediate part that connects the base portion and the top portion.

8. The outdoor robotic work tool interaction station according to claim 7, wherein at least one of the first, second and third radar reflective targets is attached to the intermediate part.

9. The outdoor robotic work tool interaction station according to claim 4, wherein the outdoor robotic work tool interaction station is a robotic lawn mower charging station, and wherein one of the first, second and third radar reflective targets is made of metallic or plastic material.

10. (canceled)

11. The outdoor robotic work tool interaction station according claim 3, wherein at least one of the first, second and third radar reflective targets is made as a corner radar reflector formed as an open pyramid that has three wall sides and an open side.

12. An outdoor robotic work tool adapted for a forward travelling direction and comprising a control unit, a charging reception arrangement adapted for making electrical contact with a charging transmission arrangement of an outdoor robotic work tool charging station, and at least one radar transceiver adapted to transmit signals and to receive reflected signals that have been reflected by at least one object, wherein the control unit is adapted to identify radar detections originating from received reflected signals that have been reflected by at least one radar reflective target, positioned at an outdoor robotic work tool interaction station, and to control the movement of the outdoor robotic work tool such that the outdoor robotic work tool moves towards the outdoor robotic work tool interaction station in dependence of information acquired by means of the at least one radar transceivers.

13. The outdoor robotic work tool according to claim 12, wherein the outdoor robotic work tool interaction station is the outdoor robotic work tool charging station, wherein the control unit is adapted to control the movement of the outdoor robotic work tool such that the outdoor robotic work tool moves to such a position at the outdoor robotic work tool charging station that enables the charging reception arrangement to make electrical contact with the charging transmission arrangement such that the outdoor robotic work tool can receive a charging current from the outdoor robotic work tool charging station.

14. The outdoor robotic work tool according to claim 12, wherein the control unit is adapted to identify radar detections originating from the received reflected signals that have been reflected by at least two radar reflective targets by comparing a configuration of the radar detections with a predetermined configuration of the at least two radar reflective targets.

15. The outdoor robotic work tool according to claim 14, wherein the control unit is adapted to distinguish between different outdoor robotic work tool interaction stations by comparing the configuration of the radar detections with different predetermined unique configurations of radar reflective targets that are associated with corresponding outdoor robotic work tool interaction stations, enabling the control unit to identify a certain outdoor robotic work tool interaction station among at least two outdoor robotic work tool interaction stations.

16. The outdoor robotic work tool according to claim 12, wherein the outdoor robotic work tool comprise at least one navigation sensor arrangement that comprises a beacon navigation sensor and/or a satellite navigation sensor.

17. The outdoor robotic work tool according to claim 16, wherein the control unit is adapted to identify radar detections originating from the received reflected signals that have been reflected by the at least one radar reflective target by comparing a calculated position of one of the at least one radar reflective target with a predetermined position of another instance of the at least one radar reflective target.

18. The outdoor robotic work tool according to claim 16, wherein the control unit is adapted to calibrate a position of an outdoor robotic work tool interaction station in dependence of a determined position of the at least one radar reflective target, positioned at the outdoor robotic work tool interaction station.

19. A method in an outdoor robotic work tool adapted for a forward travelling direction, wherein the method comprises:
transmitting signals; and
receiving reflected signals where the transmitted signals have been reflected by at least one object;
wherein the method comprises:
identifying radar detections originating from received reflected signals that have been reflected by at least one radar reflective target, positioned at an outdoor robotic work tool interaction station, and
controlling movement of the outdoor robotic work tool such that it moves towards the outdoor robotic work tool interaction station in dependence of information acquired by radar transceivers.

20. The method according to claim 19, wherein the outdoor robotic work tool interaction station is an outdoor robotic work tool charging station, wherein the method comprises making electrical contact between the charging reception arrangement and the charging transmission arrangement such that the outdoor robotic work tool can receive a charging current from the outdoor robotic work tool charging station.

21. The method according to any one of the claim 19, wherein the method comprises identifying radar detections originating from the received reflected signals that have been reflected by at least two radar reflective targets by comparing a configuration of the radar detections with a predetermined configuration of the at least two radar reflective targets.

22. The method according to claim 19, wherein the method comprises distinguishing between different outdoor robotic work tool interaction stations by comparing the configuration of the radar detections with different predetermined unique configurations of radar reflective targets that are associated with corresponding outdoor robotic work tool interaction stations), enabling identification of a certain outdoor robotic work tool interaction station among at least two outdoor robotic work tool interaction stations.

23. The method according to claim 19, wherein the outdoor robotic work tool uses at least one navigation sensor arrangement with a beacon navigation sensor and/or a satellite navigation sensor, and wherein the method comprises identifying radar detections originating from received reflected signals that have been reflected by at least one radar reflective target by comparing a calculated position of one of the at least one radar reflective target with a predetermined position of another instance of the at least one radar reflective target.

24. (canceled)

25. The method according to claim 23, wherein the method comprises calibrating a position of an outdoor robotic work tool interaction station in dependence of a determined position of at least one radar reflective target, positioned at the outdoor robotic work tool interaction station.
